(19) United States
(12) Patent Application Publication
(10) Pub. No.: US 2019/0095608 A1
(43) Pub. Date: Mar. 28, 2019

(54) Systems and Methods for Facilitating User Authentications in Network Transactions

(71) Applicant: MASTERCARD INTERNATIONAL INCORPORATED, Purchase, NY (US)

(72) Inventor: Manoneet Kohli, O'Fallon, MO (US)

(21) Appl. No.: 15/715,881

(22) Filed: Sep. 26, 2017

(51) Int. Cl. G06F 21/43; G06Q 20/42; G06Q 20/40

(52) U.S. Cl. CPC G06F 21/43; H04W 4/02; G06Q 20/4014; G06Q 20/425

(57) ABSTRACT

Systems and methods are provided for use in facilitating user authentication in connection with network transactions. One exemplary method includes detecting a transaction involving an account and a merchant, where the account is provided by a first issuer to a user and is associated with a region of the user, and identifying, by a computing device, a region of the merchant involved in the transaction. The method also includes appending, by the computing device, the region to a region list, when the identified region is different from the region of the payment account, and transmitting a region indicator for the user to a second issuer of a different account associated with the user, whereby the second issuer is permitted to rely on inclusion of the region of the merchant in the region list to approve a further transaction by the user involving the second issuer.

### FIELD

The present disclosure generally relates to systems and methods for facilitating user authentications in connection with network transactions, and in particular, to systems and methods for applying user authentications for accounts in one region to network transactions associated with other accounts in the same region.

### BACKGROUND

This section provides background information related to the present disclosure which is not necessarily prior art.

Payment account transactions are employed ubiquitously in commerce, whereby consumers use payment accounts, provided by issuing banks, to purchase products (e.g., goods and/or services) from merchants. Typically, such payment account transactions involve merchants in one region, where the consumers are located and/or are associated with the same region (e.g., where billing addresses of the consumers' payment accounts are within the region, etc.). Occasionally, though, the consumers may travel to one or more other regions and attempt transactions with merchants in those other regions through their payment accounts. In addition, fraud rules and/or algorithms are often employed in connection with payment account transactions, where the fraud rules and/or algorithms rely on the regions in which the merchants are located (as compared to the region of origin of the payment accounts used in the transactions). In connection therewith, transactions by the consumers in certain regions may be determined, based on the fraud rules and/or algorithms, to be more risky than transactions by the consumers in other regions and may potentially be declined. As can be appreciated, the declines are provided to safeguard against unauthorized purchases to the consumers' payment accounts by fraudsters.

### DRAWINGS

The drawings described herein are for illustrative purposes only of selected embodiments and not all possible implementations, and are not intended to limit the scope of the present disclosure.

FIG. 1 illustrates an exemplary system of the present disclosure in which authentication of a consumer in one region, in connection with a transaction in the one region by the consumer to an account, may be used as an indication of authentication of the consumer in the one region in connection with one or more other transactions to different accounts associated with the consumer;

FIG. 2 is a block diagram of a computing device that may be used in the exemplary system of FIG. 1; and

FIG. 3 is an exemplary method that may be implemented in connection with the system of FIG. 1 for using authentication of a consumer in a region in connection with one transaction as an indication of authentication of the consumer in that region for other transactions.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment accounts are often issued to consumers in regions in which the consumers are located or reside (e.g., the consumers' home regions, the consumers' listed regions, etc.). The consumers then often engage in purchase transactions in those regions using their payment accounts. Occasionally, the consumers will engage in purchase transactions outside of the regions in which their payment accounts are issued, for example, when traveling for work or pleasure, etc. When the consumers are outside of these regions, their purchase transactions may be subject to additional scrutiny in connection with fraud prevention, etc.

Uniquely, the systems and methods herein permit issuers of payment accounts to be informed of authentications of consumers in different regions, outside of the regions in which their payment accounts are issued, thereby allowing the scrutiny of the transaction (e.g., in connection with fraud prevention, etc.) to be adjusted accordingly. In particular, when a consumer engages in a purchase transaction using a first account, the consumer may be authenticated through one or more “strong” authentication procedures (e.g., entering a personal identification number (PIN), providing a biometric, via an enhanced authentication procedure (e.g., 3-D Secure™ protocol, etc.), etc.). Then, when the consumer is authenticated, an authentication engine (or platform) may communicate the authentication to an issuer of the consumer's first payment account, and/or to an issuer of a different payment account associated with the consumer. For example, the authentication engine may provide an advisement to the issuer(s), or the authentication engine may provide a region indicator to the issuer when involved in a subsequent transaction to the different account for the consumer (e.g., by modifying the authorization request, etc.). What's more, when a payment network associated with the authentication engine is providing fraud services (e.g., on behalf of the issuer(s), on behalf of the consumer, etc.), the authentication in the region of the consumer for the transaction to the first account may be provided to the fraud algorithm as a basis for a fraud score that is delivered to the issuer of the different account. In this manner, issuers may be informed of authentications of consumers (related to other issuers and/or payment accounts) in specific regions, whereby the issuers are permitted to rely on that authentication to avoid improperly declining purchase transactions by the consumers.

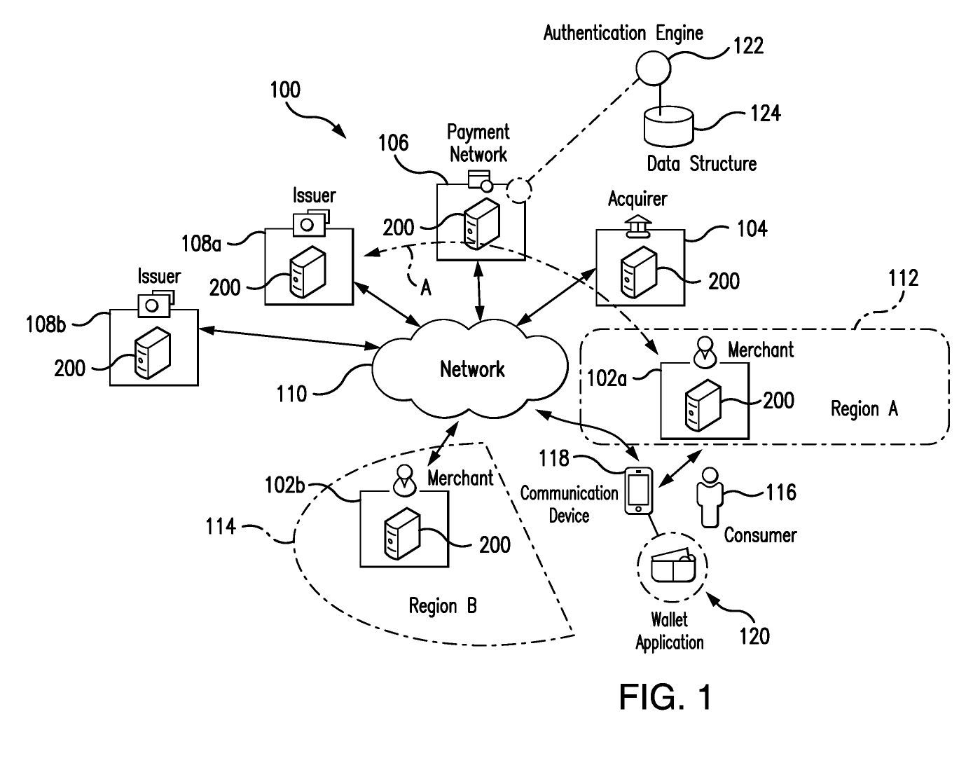

FIG. 1 illustrates an exemplary system 100, in which one or more aspects of the present disclosure may be implemented. Although the system 100 is presented in one arrangement, other embodiments may include the parts of the system 100 (or other parts) arranged otherwise depending on, for example, alternative regional groupings in the system 100, differing transactional roles between parts of the system 100, additional parties to transactions in the system 100, etc.

The system 100 generally includes two merchants 102a-b, an acquirer 104 generally associated with each of the merchants 102a-b, a payment network 106, and two issuers 108a-b, each of which is coupled to (and is in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108a, for example, and, separately, the public Internet, which may provide interconnection between the merchants 102a-b and the acquirer 104 (as appropriate), etc.

The illustrated system 100 also includes border lines 112 and 114 generally defining (or generally delineating between) Region A and Region B. The different Regions A and B may represent different countries, states, territories, counties, postal codes, cities, and/or any other suitable geographical demarcations, etc. Notably, in this exemplary embodiment, the merchant 102a is disposed or located in Region A, while the merchant 102b is disposed or located in Region B. With that said, Regions A and B are not drawn to include the acquirer 104, the payment network 106, the issuers 108a-b, or a consumer 116 in the illustrated system 100, as their relative locations to the merchants 102a-b are unimportant, generally, to the disclosure herein and/or will change consistent with the description herein (e.g., the consumer 116 may travel between Regions A and B, etc.). With that said, it should be appreciated that the system 100 is not illustrated in FIG. 1 to indicate the actual physical arrangement of the parts of the system 100, but instead provides a general location of the merchants 102a-b (and potentially, the consumer 116) within the specified Regions A and B, thereby indicating a relative position as described herein.

The consumer 116 in the system 100 is associated with multiple payment accounts, each of which is issued by one of the issuers 108a-b. For reference herein, a payment account A is issued to the consumer 116 by the issuer 108a, and a payment account B is issued to the consumer 116 by the issuer 108b. What's more, the consumer 116 is associated with at least one location in Region A (e.g., a residence, a home, a condominium, an apartment, etc.) that is provided and/or communicated to the issuers 108a-b in connection with the payment accounts (e.g., during issuance of the payment accounts A and B, etc.). For example, the consumer 116 may reside at a location within Region A, which the issuers 108a-b then identify as a billing address for the consumer 116 for the payment accounts A and B. In this manner, Region A is understood to be a listed region for the consumer's payment accounts A and B and/or for the consumer 116.

As further shown in FIG. 1, the consumer 116 is associated with a communication device 118. The communication device 118, in turn, includes a virtual wallet application 120 (or virtual wallet, or electronic wallet, or e-wallet, etc.). The virtual wallet application 120 may be provided by any one or more of the payment network 106, the issuers 108a-b, or another entity, etc. in the system 100 and may include, without limitation, MasterPass® from MasterCard®, Apple Pay® from Apple®, PayWave®, etc. The virtual wallet application 120 includes executable instructions that configure the communication device 118 to operate as described herein. In general, the virtual wallet application 120 permits the consumer 116 to present, electronically, a payment account within the application 120 to one or more merchants (e.g., to one or both of merchants 102a-b, etc.) to fund purchase transactions through the payment account. In this exemplary embodiment, each of payment account A and the payment account B are associated with and/or included in the consumer's virtual wallet application 120 at the communication device 118.

In connection therewith, the virtual wallet application 120 at the consumer's communication device 118 may be provisioned with a token in association with each of the payment accounts A and B (such that each of the payment accounts A and B includes its own token). A token (e.g., a payment token, etc.), generally, is an electronic data set including credentials that may be used in a purchase transaction in place of traditional payment credentials and which is uniquely associated to a domain, such as, for example, a computing device (e.g., the communication device 118, etc.), a merchant (e.g., one of the merchants 102a-b, etc.), etc. The token is generally sufficient to be employed in the virtual wallet application, for example, as included at the communication device 118 (e.g., including the token, token card data (e.g., expiration data, verification code, etc.) and token EMV keys, etc.), etc. Because the token is directly associated to a domain (e.g., a computing device such as communication device 118, etc.), theft of the token may be inconsequential to the consumer 116, since the token is unusable if not used in conjunction with the proper domain. Thus, in the illustrated embodiment, the use of the token can enable electronic payment transactions involving the communication device 118 with greater security and without a sacrifice to efficiency or convenience.

With that said, as needed in the system 100, the acquirer 104, the payment network 106, and one of the issuers 108a-b cooperate to authorize, clear and settle a transaction between one of the merchants 102a-b and the consumer 116, when the consumer 116 presents one of his/her payment accounts A and B thereto as part of a purchase transaction.

In particular, for example, when the consumer 116 desires to purchase a product from the merchant 102a, the consumer 116 presents a payment device to the merchant 102a. The payment device, in this example, is the communication device 118 with the virtual wallet application 120 included and active therein (and with the payment account A designed for use). The merchant 102a, in turn, is configured to capture one or more payment account credentials (e.g., a payment token, a primary account number (PAN), an expiration date, etc.) for the consumer's payment account A from the virtual wallet application 120, for example, via the communication device 118, and to compile an authorization request (broadly, an authorization message) for the purchase transaction. The authorization request may include, for example, the PAN for the consumer's payment account A and an amount of the transaction, etc.

Once compiled, the merchant 102a is configured to transmit the authorization request to the acquirer 104 (via the network 110). The acquirer 104, in turn, is configured to communicate the authorization message with the issuer 108a (associated with payment account A) through the payment network 106 (again via the network 110), for authorization of the transaction (generally along path A in FIG. 1). The issuer 108a then determines if the consumer's payment account is in good standing and if sufficient credit/funds to complete the transaction are associated with the payment account A. In this example, if the issuer 108a approves/accepts the transaction, an authorization reply (broadly, another authorization message) is provided by the issuer 108a back to the merchant 102a authorizing the transaction, and the merchant 102a completes the transaction. The credit line or funds associated with the consumer's payment account A, depending on the type of payment account, is then decreased by the amount of the transaction/payment, and the charge is posted to the payment account A. The transaction is later cleared and settled by and between the merchant 102a and the acquirer 104 (in accordance with a settlement arrangement, etc.), and by and between the acquirer 104 and the issuer 108a (in accordance with another settlement arrangement, etc.).

While described with reference to merchant 102a and payment account A, it should be understood that a purchase transaction with the merchant 102b and/or a purchase transaction funded by the payment account B (and involving the issuer 108b) would be substantially consistent with the description above.

In connection with the various payment account transactions in the system 100, transaction data is generated, collected, and stored as part of the interactions among the merchants 102a-b, the acquirer 104, the payment network 106, and the issuers 108a-b, etc. (as exemplified in the transaction above). The transaction data includes a plurality of transaction records, one for each transaction, or attempted transaction. The transaction records, in this exemplary embodiment, are stored at least by the payment network 106 (e.g., in a data structure associated with the payment network 106, etc.) (e.g., as authorization messages, clearing messages or records, etc.). As generally described above, the transaction records may include, for example, payment account numbers or other IDs, amounts of transactions, merchant names, merchant IDs, merchant locations, transaction types, transaction channels, dates/times of the transactions, currency codes, country codes, merchant category codes (MCCs), processing codes or other suitable dimensions of a transaction, as described below, or otherwise, etc. (broadly, all transaction data). It should be appreciated that more or less information related to transactions, as part of either authorization or clearing and/or settling, may be included in transaction records and stored within the system 100, at the merchants 102a-b, the acquirer 104, the payment network 106, and/or the issuers 108a-b.

In the embodiments herein, consumers involved in the different transactions are prompted to agree to legal terms associated with their payment accounts, for example, during enrollment in their accounts, during installation of payment applications to their communication devices, etc. In so doing, the consumers voluntarily agree, for example, to allow merchants, issuers, payment networks, etc., to use transaction data generated and/or collected during enrollment and/or in connection with processing the transactions, for subsequent use in general, and as described herein.

It should be appreciated that while only two merchants 102a-b, one acquirer 104, one payment network 106, and two issuers 108a-b, along with two Regions A and B, are included in the system 100, other system embodiments will generally include multiple of each of the parts and/or regions, all with interactions as described above by and between the various parts. Likewise, while only one consumer 116 and one communication device 118 are illustrated, a different number of each is contemplated to be included in other system embodiments.

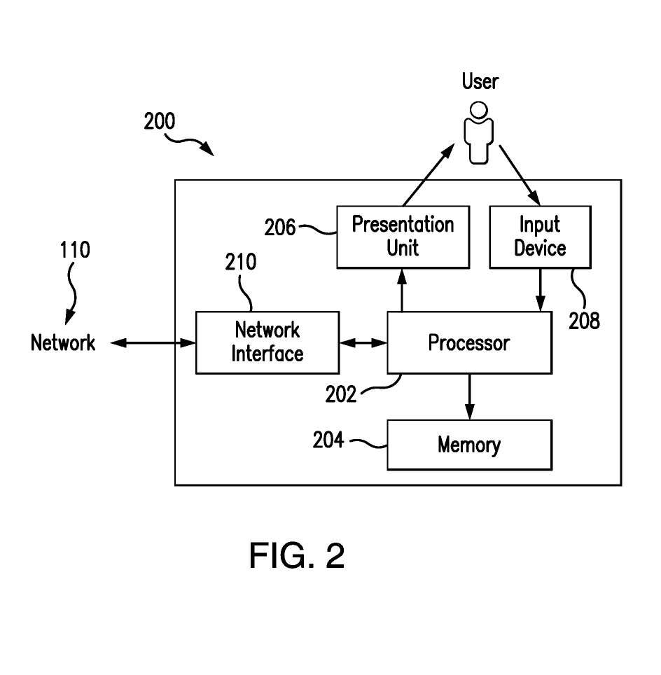

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. In the exemplary system 100 of FIG. 1, each of the merchants 102a-b, the acquirer 104, the payment network 106, and the issuers 108a-b are illustrated as including, or being implemented in, computing device 200, coupled to (and in communication with) the network 110. Additionally, the communication device 118 associated with the consumer 116 is also substantially consistent with the computing device 200. That said, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured, as one or more data structures, to store, without limitation, listed regions (and corresponding region lists), other regions, payment account numbers or other credentials, authentication instances, and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer-readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., requests for authentication, confirmations of authentications, etc.), visually, for example, to a user of the computing device 200. It should be further appreciated that various interfaces (e.g., as defined by network-based applications, websites, etc.) may be displayed at computing device 200, and in particular at presentation unit 206, to display certain information to the user. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

The computing device 200 also includes an input device 208 that receives inputs from the user (i.e., user inputs) such as, for example, a personal identification number (PIN), a biometric, or other suitable authentication inputs, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, etc. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth™ adapter, etc.), a mobile network adapter, or other device capable of communicating to one or more different networks, including the network 110. Further, in some exemplary embodiments, the computing device 200 may include the processor 202 and one or more network interfaces incorporated into or with the processor 202. In various embodiments, the computing device 200 may additionally include a global positioning system (GPS) capability whereby the computing device 200 may determine its current geographic location, perform mapping applications, etc. For example, the consumer 116 may utilize the GPS capability of his/her communication device 118 (directly or indirectly) to locate the consumer 116 in connection with a purchase transaction, as described below.

Referring again to FIG. 1, the system 100 includes an authentication engine 122 specifically configured, by executable instructions, to operate as described herein. The authentication engine 122 is illustrated as a standalone part of the system 100 and, in this manner, may be considered one or more computing devices consistent with computing device 200. Additionally, or alternatively, the authentication engine 122, as indicated by the dotted line in FIG. 1, may be integrated, in whole or in part, with the payment network 106 (e.g., as part of the computing device 200 associated therewith, etc.). In addition, the authentication engine 122 is coupled to data structure 124, which may be standalone from the authentication engine 122 or integrated therewith in whole or in part (and by extension with the payment network 106, when the authentication engine 122 is integrated therein). In other embodiments, the authentication engine 122 may be integrated in whole or in part with one of the issuers 108a-b (e.g., as part of the computing device 200 associated therewith, etc.), etc.

In the illustrated system 100, each of the issuers 108a-b is registered with the authentication engine 122, in order to receive communications related to authentication of the consumer 116 in one or more regions (e.g., region indicators, etc.), when the one or more regions are not the listed Region A for the consumer 116. In connection with the registration, the authentication engine 122 is configured to solicit, and the issuers 108a-b are configured to provide, region data for the consumer 116 for inclusion in the region list data structure 124 (e.g., a home region for the consumer 116, particular regions in which the consumer 116 frequently transacts, etc.). In this manner, the authentication engine 122 may compile a listing of regions for the consumer 116 as described herein for storing in the data structure 124. In addition, the authentication engine 122 is configured to solicit, and the issuers 108a-b are configured to provide, different rules (e.g., as part of and/or based on issuer risk assessment profiles for the issuers 108a-b, etc.) related to the authentications and corresponding communications. Specifically, for example, the issuer 108b may indicate that an authentication of the consumer 116 by a different issuer (e.g., issuer 108a, etc.) for a transaction in a region different from Region A may be relied upon in scrutiny of a transaction in the same region directed to the issuer 108b (e.g., in application of fraud rules, etc.) for a defined interval of twelve hours, or one day, or some other interval, whereby the authentication of the consumer 116 by the other issuer is accounted for, but not overly relied upon. Other rules may relate, apart from an indication of the newly listed region or in combination therewith, to the type of authentication performed by the different issuer (e.g., biometric authentication, PIN authentication, 3-D Secure™ protocol, EMV-based authentication, etc. or a combination thereof), to a channel used for the subsequent transaction (e.g., the wallet application 120, presentation of a physical payment card, etc.), to transaction frequency, transaction amount(s), transaction type (e.g., an online transaction where dynamic verification may be performed versus offline transaction, etc.), etc. (whereby the identified region of the transaction may be appended to the region list based on the particular rule). For example, the issuer 108b may permit use of authentication of the consumer 116 by a different issuer for a defined period of one day when the authentication is pursuant to the 3-D Secure™ protocol, but only eight hours when the authentication is based on a PIN. Or, for example, the issuer 108b may use authentication of the consumer 116 by a different issuer, as performed by the consumer 116 at his/her wallet application 120 (e.g., via a PIN, a biometric, a one-time password, etc.), for a transaction in a given region, in connection with evaluating risk for a subsequent transaction by the consumer 116 in the same given region and involving the issuer 108b (e.g., involving payment account B, etc.).

With that said, and as generally discussed above, the consumer 116, from time to time, will cause purchase transactions funded by either the payment account A or the payment account B. In so doing, the consumer 116 may be located in Region A (e.g., the consumer's listed region or home region, etc.) where the transaction may involve merchant 102a, or the consumer 116 may be located in Region B where the transaction may involve merchant 102b. When the consumer 116 initiates a purchase transaction for a product at merchant 102b, in Region B, using payment account A, the consumer 116 will be invited to authenticate himself/herself, for example, by a password, a PIN, an authentication indicia (e.g., a QR code, etc.), a biometric, or a challenge question/input, etc. (e.g., at a point-of-sale (POS) device associated with the merchant 102b (local to the POS device or pursuant to a network-based service), via the wallet application 120 at the consumer's communication device 118 (e.g., for displaying and/or receiving an authentication indicia, for providing a device-based client certificate, for providing and/or receiving a one-time password, for displaying a challenge question (and for capturing a response thereto), etc.), etc.). Additionally, or alternatively, the authentication may occur in connection with an EMV-enabled payment device (e.g., a credit card, etc.). Regardless of the particular type of authentication, the purchase transaction is permitted to proceed when the consumer 116 is authenticated (wherein the merchant 102b generates an authorization request for the transaction as described above).

In connection therewith, the authentication engine 122 is configured to detect the transaction between the merchant 102b and the consumer 116 (e.g., based on the authorization request for the transaction transmitted by the merchant 102b to the payment network 106, via the acquirer 104; etc.). For example, the authentication engine 122 may detect the transaction based on the issuers 108a-b involved in the transaction being registered to the authentication engine 122. In particular, the authentication engine 122 may identify the issuer based on an account number for payment account A used in the underlying transaction being within a range of account numbers associated with one of the issuers 108a-b.

The authentication engine 122 is also configured to identify a region associated with the transaction (e.g., Region B in the above transaction based on the location of the consumer 116 and/or the location of the merchant 102b, etc.). For example, the authentication engine 122 may be configured to detect an address of the merchant 102b, a merchant category code (MCC) for the merchant 102b, a merchant ID for the merchant 102b, a country for the merchant 102b and/or the transaction, a currency used in the transaction, etc. from the authorization request (or, potentially, the authorization reply) for the transaction, where the region of the merchant 102b (and thus the region of the transaction) in Region B is then readily understood and/or determinable (e.g., for a card-present transaction, etc.). In particular, the authentication engine 122 may be configured to detect a merchant ID for the merchant 102b from the authorization request and then look up a location for the transaction based on the merchant ID, thereby identifying the region of the merchant 102b (and thus the region of the transaction) as Region B (for a card-present transaction). Additionally, or alternatively, when the underlying transaction involves use of a payment token, the authentication engine 122 may be configured to communicate with a token service provide (associated with provisioning the token to the consumer 116 and/or the communication device 118 for the payment account A), to confirm that the transaction is complete and to obtain an address (and/or other information) for the merchant 102b. Further, when the transaction is initiated through the consumer's communication device 118 (e.g., a card-not present transaction involving 3-D Secure authentication, etc.), the authentication engine 122 may be configured to determine a region of the consumer 116 (and thus the region of the transaction) from the GPS capability associated with the communication device 118 and/or based on network addressing associated with the communication device 118 when used in connection with authentication of the consumer 116 and/or initiating the transaction. Moreover, for a digital transaction, the authentication engine 122 may be configured to utilize a geolocation for an internet protocol (IP) address for a last know transaction by the consumer 116 to thereby identify the location.

Then in the system 100, once the region of the transaction is identified, the authentication engine 122 is configured to append the identified region (e.g., Region B in the above example, etc.) to the region list associated with the consumer 116 (e.g., where the region list then includes Region A as the consumer's home location and Region B based on identification thereof in the above transaction, etc.). In turn, the authentication engine 122 is configured to store and/or maintain and/or update the region list associated with the consumer 116 and/or other consumers in the data structure 124. It should be appreciated that the authentication engine 122 may update the region list as desired, for example, to remove regions therefrom when transactions have not been performed in such regions within a defined time period (e.g., one week, two weeks, one month, etc.).

Thereafter, for subsequent transactions by the consumer 116 in a particular region, the authentication engine 122 is configured to communicate the presence of the consumer 116 in the identified region, when the identified region is different than the consumer's listed region(s) (e.g., different than Regions A and B for the consumer 116, etc.), for each of the consumer's payment accounts (e.g., to the issuers 108a-b for each of the consumer's payment accounts A and B herein, etc.). In connection therewith, in a first application, for subsequent transactions by the consumer 116, the authentication engine 122 may be configured to transmit advisements to the issuers associated with the transactions for the newly identified regions. The advisements may include, for example, times and dates of the transactions, types and/or descriptions of the authentications completed for the transactions, etc. In this manner, the issuers are notified of the recent transactions, whereby the issuers may be able to modify their fraud rules and/or algorithms accordingly. In addition to the advisement, or as an alternative thereto, in a second application the authentication engine 122 and/or the payment network 106 may be configured to intercept authorization requests for the subsequent transactions, and to append region indicators to the authorization requests (as indicated by the region list in data structure 124) before passing the authorization requests along to the appropriate issuers (e.g., to one of the issuers 108a-b, etc.). Again, in this manner, the issuers are notified of the recent transactions and the authentication of the consumer 116 in the listed region(s), whereby the issuer 108b may be able to modify its fraud rules and/or algorithms accordingly.

In a third application, the payment network 106 may be configured to provide fraud scoring directly for the subsequent transactions, on behalf of the issuers (e.g., on behalf of the issuers 108a-b, etc.). As such, the authentication engine 122 and/or the payment network 106 may be configured to intercept authorization requests for the subsequent transactions when identified in a listed region(s) of the region list in the data structure 124, to determine fraud scores for the transactions, where the fraud scores account for the prior authentications of the consumer in the listed region(s) (e.g., Region A and Region B, etc.), and to then append the fraud scores to the authorization requests, before passing them along to the issuers. Again, in this manner, the issuers are able to rely of the fraud scores to approve or decline the transactions.

It should be appreciated that the authentication engine 122 may be further configured to provide the advisements, append the region indicators, and/or account for the recent authentications in one or more fraud services provided to the issuers 108a-b. In connection therewith, the authentication engine 122 may be configured to rely on the one or more rules imposed by the issuers 108a-b, at registration, for example. Specifically, for example, the authentication engine 122 may be configured to only append the region indicators to authorization messages for purchase transactions when the region(s) included in the region list for the consumer 116 is/are the same as the region(s) identified from the authorization messages, and the authentication of the consumer 116 occurred within the last twenty-four hours. Other rules may be selected and/or imposed by the authentication engine 122, as will be described in more detail below.

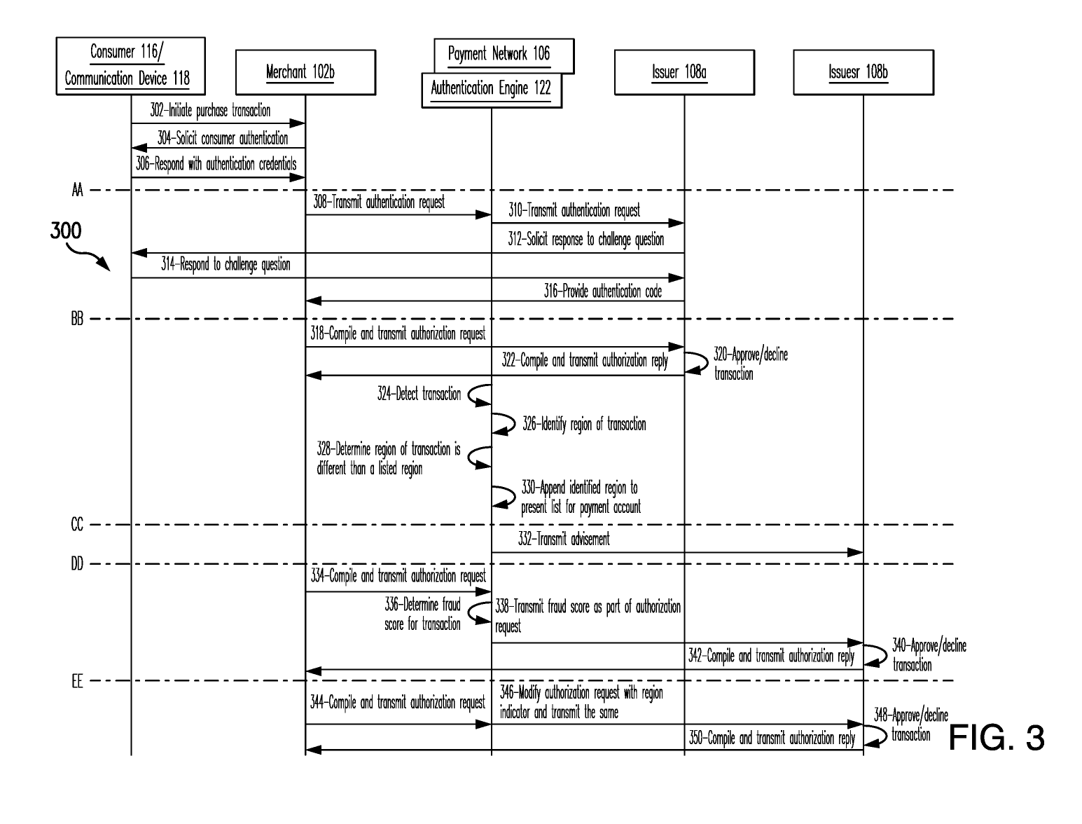

FIG. 3 illustrates an exemplary method 300 in which authentication of a consumer in connection with a first transaction may be used as a basis for authenticating the consumer in connection with other, subsequent purchase transactions in the same region. The exemplary method 300 is described as implemented in the authentication engine 122 of the system 100, with additional reference to the other parts thereof. However, the method 300 is not limited to the authentication engine 122, or more generally, to the system 100. Further, the exemplary method 300 is described herein with reference to the computing device 200. But the methods herein should not be understood to be limited to the exemplary computing device 200. Likewise, the systems and computing devices herein should not be understood to be limited to the exemplary method 300.

The method 300 is also described with reference to two exemplary transactions, Transaction #1 and Transaction #2. Transaction #1 is between the consumer 116 and the merchant 102b in Region B and is funded by payment account A. And, Transaction #2 is between the consumer 116 and the merchant 102b in Region B and is funded by payment account B.

With regard to Transaction #1, the consumer 116 selects a product from the merchant 102b in Region B and initiates, at 302, a purchase transaction for the product, funded by the payment account A (e.g., via his/her wallet application 120, etc.). In connection therewith, the consumer 116 is authenticated in one or more manners. In particular, the merchant 102b solicits, at 304, an authentication input for the consumer 116, such as, for example, a biometric (e.g., a fingerprint, etc.), a PIN, or other suitable information (as described above in connection with the system 100). In turn, the consumer 116 responds, at 306, with the solicited input for authentication.

Optionally, as shown between dotted lines AA and BB in FIG. 3, the payment account may be associated with enhanced authentication, such as, for example, 3-D Secure™ protocol, etc. As a result, upon initiation of the Transaction #1 (when the transaction is an online purchase or other card-not-present transaction, etc.), the merchant 102b (or merchant plug-in (MPI) associated therewith) transmits, at 308, an authentication request to the payment network 106, which, in turn, transmits the authentication request to the issuer 108a, at 310. The issuer 108a, in connection with an access control server (ACS), authenticates the consumer 116 by soliciting, at 312, a response to a challenge question from the consumer 116, at the communication device 118. The challenge question may solicit, for example, a code known to the consumer 116 (e.g., a SecureCode® private code by MasterCard, etc.), or other information sufficient to authenticate the consumer 116. At 314, the consumer 116 responds to the challenge question. And, when the response is acceptable (e.g., a match, etc.), the issuer 108a (or the ACS) returns an authentication code to the merchant 102b, at 316.

In at least one other embodiment, although not shown in FIG. 3, the consumer 116 may be authenticated by cooperation between the merchant 102b and the payment device presented by the consumer 116 (e.g., the communication device 118, etc.). For example, the payment device may include a reference biometric, which is compared (on the payment device or by the merchant 102b) to a biometric captured form the consumer 116 at the time of the purchase transaction. An authentication flag may then be generated by the merchant 102b and/or communicated from the payment device to the merchant 102b when the consumer 116 is authenticated.

In at least another embodiment, the consumer 116 may be authenticated in connection with an EMV-enabled payment device (e.g., a credit card, etc.), in a generally conventional manner. In the case of the EMV-enabled payment device, however (as compared to authentication using a biometric), Transaction #1 will translate or be captured upon authorization such that the authentication data is still available for use in evaluating subsequent transactions (even if Transaction #1 is subsequently abandoned or halted by the consumer 116 post authentication).

Thereafter in the method 300, regardless of the manner of authentication of the consumer 116, the merchant 102b next compiles and transmits, at 318, an authorization request for the purchase transaction to the issuer 108a (via the acquirer 104 and the payment network 106). The authorization request includes the PIN (or biometric or other authentication indicia), the authentication code and/or the authentication flag, as appropriate. Upon receipt of the authorization request, the issuer 108a approves (or declines) the purchase transaction, at 320. In connection therewith, the issuer 108a further authenticates the consumer 116. For example, the issuer 108a may compare the PIN (or biometric or other authentication indicia) from the authorization request to a reference stored at the issuer 108a and associated with the payment account A. Additionally, or alternatively, the issuer 108a may check the authentication code against the authentication codes provided to the merchant 102b (and/or provided from the ACS). Or, the issuer 108a may check the authentication flag, to confirm it is set properly (e.g., 2 for authenticated, 1 for not authenticated, etc.).

In any case, the issuer 108a responds to the authorization request by compiling and transmitting, at 322, an authorization reply to the merchant 102b (via the payment network 106 and the acquirer 104). Upon receipt, the merchant 102b is able to conclude the purchase transaction with the consumer 116.

In connection with the above, the authentication engine 122 detects the transaction, at 324, based on the issuer 108a, for example, when the issuer 108a associated with the transaction is registered to the authentication engine 122 (e.g., at the payment network 106, etc.). Once detected, the authentication engine 122 identifies, at 326, a region of the transaction (e.g., a region associated with the merchant 102b and/or the consumer 116, etc.). For a card-present transaction (as indicated in the authorization request or authorization reply), the authentication engine 122 may identify the region of the consumer 116 and/or the merchant 102b based on a merchant address included in the authorization request (or reply) compiled from the merchant 102b (at 318). Apart from the merchant address, the authentication engine 122 may alternatively identify the region based on a merchant ID included in the authorization request (or in any of the manners described above in the system 100, etc.). Specifically, the authentication engine 122 may access a database that includes the merchant ID's of multiple merchants along with the addresses and/or regions of the merchants and search for the merchant ID from the authorization request to find the corresponding address/region. Additionally, when the transaction is card-not-present, the authentication engine 122 may identify the region of the consumer 116 based on the interaction between the issuer 108a and the communication device 118 at steps 312 and 314 (e.g., based on host IP address mapping, geo-IP address tracking/mapping, cellular data mapping, etc.).

Through one or more of the above, the authentication engine 122 identifies the location of Transaction #1 as Region B (at 326). The authentication engine 122 then compares, at 328, the identified region (Region B) to a listing of regions for the payment account A (in data structure 124), which in this example includes only Region A (as the listed or home region for the consumer 116). Because the region identified, i.e., Region B, is different than Region A, the authentication engine 122 appends, at 330, the Region B to the region listing in the data structure 124 for the consumer 116. In response to appending the region for the consumer 116 to the region list, the authentication engine 122 has multiple options in notifying and/or leveraging the region listed on behalf of the registered issuers (e.g., issuers 108a-b, etc.). In FIG. 3, for example, the authentication engine 122 may operate consistent with one or more of three options (which are not necessarily mutually exclusive), designated below each of the dotted lines referenced CC, DD, and EE.

In a first option referenced at dotted line CC, the authentication engine 122 may transmit, at 332, an advisement to the issuer 108b. The advisement may include an identifier associated with the consumer 116 (e.g., a name, a payment account number, etc.), and the region of the authentication (e.g., Region B). In response, the issuer 108b may rely on the advisement in connection with approving or declining subsequent transactions, and specifically, when determining risk associated with the subsequent transactions (such as Transaction #2). For example, when an authorization request for a further transaction (such as Transaction #2), by the consumer 116 in Region B, is received by the issuer 108b, the issuer 108b may be able to determine a lower risk for the transaction because of the consumer's recent authentication within Region B for Transaction #1 within a defined interval (e.g., within the last day, the last eight hours, the last four hours, or more or less, etc.).

In a second option referenced at dotted line DD, the consumer 116 may initiate another purchase transaction with the merchant 102b, but fund the transaction with payment account B (i.e., Transaction #2). Like above, the merchant 102b compiles and transmits, at 334, an authorization request for Transaction #2 to the issuer 108b, which is intercepted by the payment network 106. In this particular option, the payment network 106 is contracted and/or obligated by the issuer 108b to provide a fraud score for the Transaction #2 along with the authorization request for the Transaction #2. As such, after intercepting the authorization request, the payment network 106 determines, at 336, a fraud score for the Transaction #2 based, at least in part on Region B now being included in the region list for the consumer 116, in the data structure 124. For example, in generating the fraud score (e.g., where a higher fraud score is more indicative of a fraudulent transaction, etc.), the payment network 106 may provide a weighting (or combination of weightings) to the prior authentication based on the above rules (e.g., depending on the authentication means (where a stronger authentication such as biometric authentication may have a lower weighting than weaker authentication means), the duration between the prior authentication and the current transaction (where a shorter duration may have a lower weighting than a longer duration, etc.), and further combine the weighting with one or more of a transaction frequency for the Transaction #2 and/or consumer 116, transaction history for the consumer 116, an amount of the Transaction #2, a merchant category (e.g., a MCC, etc.) and/or merchant type for the merchant 102b, a location of the Transaction #2, and a transaction type (e.g., online whereby this factor would contribute to a lower fraud score or fraud risk, versus offline whereby this factor would contribute to a higher fraud score or fraud risk; etc.). With that said, the particular manner in which the fraud score is determined in this option (e.g., the particular algorithm utilized, the particular weightings used, the particular factors relied upon, combinations thereof, etc.) may be dependent on the particular region at issue, the issuer involved, etc. Once the fraud score is determined, the payment network 106 and/or the authentication engine 122 transmit(s), at 338, the authorization request with the fraud score appended thereto to the issuer 108b. Thereafter, the issuer 108b approves or declines the purchase transaction, based, at least in part, on the fraud score, at 340, and then compiles and transmits an authorization reply for the Transaction #2 (indicating approved or decline) to the merchant 102b, at 342.

In a third option referenced at dotted line EE, the consumer 116 may initiate still another purchase transaction with the merchant 102b, and fund the transaction with payment account B (i.e., Transaction #2). Like above, the merchant 102b compiles and transmits, at 344, an authorization request for the Transaction #2 to the issuer 108b, which is intercepted by the payment network 106. The payment network 106 and/or the authentication engine 122 modifies, at 346, the authorization request to include a region indicator, when the region indicated in the authorization request matches or does not match a region included in the region list for the consumer 116 (e.g., is a new transacting region for the consumer 116, etc.). The region indicator may include a code for the region of the purchase transaction (Transaction #2) being included in the region list in the data structure 124, and a different code for the region not being included in the region list (e.g., “1” not included, or “2” included, etc.). Once the region indicator is determined, the payment network 106 and/or the authentication engine 122 transmit(s) the authorization request to the issuer 108b. Thereafter, the issuer 108b approves or declines the purchase transaction, based, at least in part on the region indicator (e.g., as part of the issuer's fraud algorithm, etc.), at 348, and then compiles and transmits an authorizations reply (indicating approved or decline) to the merchant 102b, at 350.

In view of the above, the systems and methods herein may permit authentication of users in connection with transactions to first accounts to be taken into account in connection with subsequent transactions by the users to second accounts. In particular, for example, the prior authentications may be used as inputs to fraud algorithms in connection with determining risks associated with the subsequent transactions by the users. In this manner, payment networks and/or issuers and/or others are permitted to rely on the prior authentications in determining the risks associated with the subsequent transactions by the same users. What's more, by making the authentications of the consumers available to different issuers, where the different issuers are associated with different payment accounts for the same consumers, the systems and methods herein provide a new and unique option for authenticating the consumers where such authentication is consumer based (such that the consumers can utilize prior authentications across their multiple accounts) instead of account based (whereby separate and independent authentications are required for different accounts for the same consumers, as is traditional).

Again and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more, or by a combination, of: (a) detecting a transaction involving an account and a merchant, the account provided by a first issuer to a user and associated with a region of the user; (b) identifying a region of the merchant involved in the transaction; (c) appending the region to a region list data structure for the consumer, when the identified region of the merchant involved in the transaction is different from the region of the payment account; (d) transmitting a region indicator for the user to a second issuer of a different account associated with the user, whereby the second issuer is permitted to rely on inclusion of the region of the merchant in the region list data structure to approve a further transaction by the user involving the second issuer; (e) detecting a type of authentication associated with the transaction; (f) appending the region to the region list data structure for the consumer, when the identified region of the merchant involved in the transaction is different from the region of the payment account and the type of the authentication is an approved type; (g) transmitting the region indicator for the user to the first issuer of the payment account, whereby the first issuer is permitted to rely on inclusion of the region of the merchant in the region list data structure to approve one or more additional transactions by the user involving the first issuer; and (h) generating a fraud score for the further transaction based on inclusion of the region of the merchant in the region list data structure.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for use in facilitating user authentication in connection with a network transaction, the method comprising:
detecting a transaction involving an account and a merchant, the account provided by a first issuer to a user and associated with a region of the user;
identifying, by a computing device, a region of the merchant involved in the transaction;
appending, by the computing device, the region to a region list data structure for the consumer, when the identified region of the merchant involved in the transaction is different from the region of the payment account; and
transmitting a region indicator for the user to a second issuer of a different account associated with the user, whereby the second issuer is permitted to rely on inclusion of the region of the merchant in the region list data structure to approve a further transaction by the user involving the second issuer.

2. The method of claim 1, wherein detecting the transaction includes detecting the transaction based on the first issuer, when the first issuer is registered to receive region indicators.

3. The method of claim 1, wherein identifying the region of the merchant includes identifying the region of the merchant based on at least one of a merchant ID and a merchant address included in an authorization request for the transaction.

4. The method of claim 3, wherein transmitting the region indicator includes transmitting an advisement to the second issuer.

5. The method of claim 1, wherein identifying the region of the merchant includes identifying the region of the merchant based on an internet protocol address associated with an interaction with the user associated with authentication the user for the transaction.

6. The method of claim 1, further comprising detecting a type of authentication associated with the transaction; and
appending, by the computing device, the region to the region list data structure for the consumer, when the identified region of the merchant involved in the transaction is different from the region of the payment account and the type of the authentication is an approved type.

7. The method of claim 6, wherein transmitting the region indicator includes modifying an authorization request for the further transaction to include the region indicator, prior to transmitting the authorization request to the second issuer.

8. The method of claim 1, further comprising transmitting the region indicator for the user to the first issuer of the payment account, whereby the first issuer is permitted to rely on inclusion of the region of the merchant in the region list data structure to approve one or more additional transactions by the user involving the first issuer.

9. The method of claim 1, further comprising generating a fraud score for the further transaction based on inclusion of the region of the merchant in the region list data structure.

10. A system for use in facilitating user authentication in connection with a network transaction, the system comprising:
a memory including a region list data structure for a consumer, the region list data structure including at least one region for the consumer;
at least one processor in communication with the memory, the at least one processor configured to:
detect a transaction by the consumer involving a payment account based on an association of the payment account with a first issuer, and identify a region of the detected transaction;
append the identified region to the region list data structure in the memory when the identified region is different from the at least one region; and
transmit a region indicator for the consumer to a second issuer of a different payment account associated with the consumer, the region indicator including the identified region, whereby the second issuer is permitted to rely on the identified region included in the region indicator in connection with approving or declining a subsequent transaction by the consumer in the identified region and involving the different payment account.

11. The system of claim 10, wherein the at least one region for the consumer included in the region list data structure includes a region in which the consumer resides.

12. The system of claim 11, wherein the at least one processor is configured, in connection with detecting the transaction by the consumer involving the payment account, to intercept an authorization message for the transaction.

13. The system of claim 12, wherein the at least one processor is configured, in connection with identifying the region of the detected transaction, to identify the region based on at least one of the merchant involved in the transaction and an internet protocol address associated with a computing device used in authenticating the consumer for the transaction.

14. The system of claim 11, wherein the at least one processor is configured, in connection with transmitting the region indicator for the consumer to the second issuer, to modify an authorization message for the further transaction to include the region indicator.

15. The system of claim 10, wherein the at least one processor is further configured to detect a type of authentication associated with the transaction; and
wherein region indicator further includes the detected type of authentication associated with the transaction.

16. The system of claim 15, wherein the at least one processor is further configured to:
generate a fraud score for the further transaction based on at least the detected type of authentication associated with the transaction; and
transmit the generated fraud score to the second issuer.

17. A non-transitory computer-readable storage media including executable instructions for facilitating user authentication in connection with a network transaction, which when executed by at least one processor, cause the at least one processor to:
detect a transaction by a consumer involving a payment account based on an association of the payment account with a first issuer, the payment account issued to the consumer by the first issuer;
detect a type of authentication associated with the transaction;
append a region associated with the transaction to a region list data structure for the consumer, when the detected type of authentication is one of a predefined type of authentication; and
transmit a region indicator for the consumer to a second issuer of a different payment account associated with the consumer, the region indicator including the appended region, whereby the second issuer is permitted to rely on the appended region included in the region indicator in connection with approving or declining a subsequent transaction by the consumer in the appended region and involving the different payment account.

18. The non-transitory computer-readable storage media of claim 17, wherein the predefined type of authentication is selected from the group consisting of biometric authentication, authentication based on input of a personal identification number, authentication based on a 3-D Secure™ protocol, EMV-based authentication, and authentication based on input of a one-time password.

19. The non-transitory computer-readable storage media of claim 17, wherein the executable instructions, when executed by the at least one processor in connection with transmitting the region indicator for the consumer to the second issuer, cause the at least one processor to modify an authorization request for the further transaction to include the region indicator, prior to the authorization request being transmitted to the second issuer.

20. The non-transitory computer-readable storage media of claim 17, wherein the executable instructions, when executed by the at least one processor, further cause the at least one processor to:
generate a fraud score for the further transaction based on at least the detected type of authentication associated with the transaction; and
transmit the generated fraud score to the second issuer.
